(19) United States
(12) Patent Application Publication
(10) Pub. No.: US 2008/0224952 A1
(43) Pub. Date: Sep. 18, 2008

(54) PLASMA DISPLAY DEVICE AND DRIVING APPARATUS THEREOF

(76) Inventors: Kazuhiro Ito, Suwon-si (KR); Tae-Wook Kim, Suwon-si (KR)

Correspondence Address: CHRISTIE, PARKER & HALE, LLP, PO BOX 7068, PASADENA, CA, 91109-7068, US

(21) Appl. No.: 11/969,132

(22) Filed: Jan. 3, 2008

(30) Foreign Application Priority Data
Mar. 12, 2007 (KR) 10-2007-0024087

(51) Int. Cl. G09G 3/28; G09G 5/00; G09G 3/10

(52) U.S. Cl. 345/60; 345/211; 315/169.4

(57) ABSTRACT

A plasma display device, and a driving apparatus thereof, is provided, which includes: a plasma display panel for displaying an image, the plasma display panel including a plurality of discharge cells and a plurality of electrodes corresponding to the discharge cells; and an electrode driver for applying a driving voltage to the plurality of electrodes, wherein the electrode driver includes: a first switch coupled between the plurality of electrodes and a first power supply for supplying a sustain voltage to the plurality of electrodes in a sustain period, a second switch having a first terminal and a second terminal, the first terminal coupled to the first power supply, the second switch for gradually increasing a voltage of the second terminal to the sustain voltage.

### CROSS-REFERENCE TO RELATED APPLICATION

This application claims priority to and the benefit of Korean Patent Application No. 10-2007-0024087 filed in the Korean Intellectual Property Office on Mar. 12, 2007, the entire content of which is incorporated herein by reference.

### BACKGROUND OF THE INVENTION

(a) Field of the Invention

The present invention relates to a driving circuit structure for a plasma display device and a driving apparatus thereof.

(b) Description of the Related Art

A plasma display device is a flat panel display for displaying texts and images using plasma generated by gas discharge. A display panel of a plasma display device includes several hundreds of thousands to several million discharge cells disposed in a matrix formation, depending on the size thereof. Hereinafter, a cell refers to a discharge cell.

Such a plasma display device is driven by dividing a frame into a plurality of subfields each having a grayscale weight value. The luminance of a cell is determined by the sum of the weight values of subfields emitting light in a corresponding cell among the plurality of subfields.

Each subfield includes a reset period, an address period, and a sustain period. The reset period is a period for initializing a wall charge state of the cells, and the address period is a period for performing an address operation to select light emitting cells and a non-light emitting cells among the discharge cells. The sustain period is period for displaying an image by sustain-discharging cells, which were set as light emitting cells during the address period, for a period corresponding to the weight of corresponding subfields.

In the reset period, the wall charge state is initialized through a weak discharge induced by applying a gradually decreasing voltage waveform to scan electrodes after applying a gradually increasing voltage waveform to the scan electrodes. Hereinafter, the reset rising waveform refers to the gradually increasing voltage waveform. In the sustain period, the sustain discharge is induced by applying sustain pulses with an opposite phase to scan electrodes and sustain electrodes.

A conventional plasma display device sets voltage levels for a voltage for a reset rising waveform and a voltage for a sustain pulse differently. Hereinafter, a reset rising voltage refers to the voltage for the reset rising waveform, and the sustain voltage refers to the voltage for the sustain pulse. Generally, the voltage level of the sustain voltage is set to be greater than that of the reset rising voltage.

Since a current path can be formed for a current to flow toward a power supply that supplies the reset rising voltage while applying the sustain voltage in the conventional plasma display device, additional elements, such as a diode and a resistor, are required for preventing the current path from being formed, thereby preventing the power supply for the reset rising voltage from being overcharged.

In order to induce an address discharge in the address period, the scan voltage that is sequentially applied to the scan electrodes is set as a negative voltage. Accordingly, a high internal potential is applied to the elements from the power supplies for supplying the reset rising voltage, the sustain voltage, and the scan voltage while applying the negative voltage to the scan electrode. Due to the high internal potential, the elements can be damaged or destroyed. Therefore, additional fuses are required in conjunction with these power supplies for supplying the reset rising voltage, the sustain voltage, and the scan voltage, as well as the fuses connected to each power supply.

Therefore, the driving circuit structure of conventional plasma display devices is complex because of the additional elements utilized for preventing overcharge and destruction of the switch.

The above information disclosed in this Background section is only for the understanding of the background of the invention. It may contain information that is not prior art that is already known to a person of ordinary skill in the art.

### SUMMARY OF THE INVENTION

An aspect of the present invention is directed toward a plasma display device and a driving apparatus thereof having advantages of a simplified circuit structure.

An embodiment of the present invention provides a plasma display device including: a plasma display panel for displaying an image, the plasma display panel including a plurality of discharge cells and a plurality of electrodes corresponding to the discharge cells; and an electrode driver for applying a driving voltage to the plurality of electrodes, wherein the electrode driver includes: a first switch coupled between the plurality of electrodes and a first power supply for supplying a sustain voltage to the plurality of electrodes in a sustain period, a second switch having a first terminal and a second terminal, the first terminal coupled to the first power supply, the second switch for gradually increasing a voltage of the second terminal to the sustain voltage.

The electrode driver may further include: a third switch coupled between the plurality of electrodes and a second power supply for supplying a first voltage that is lower than the sustain voltage, a fourth switch coupled between the plurality of electrodes and a third power supply for supplying a scan voltage to the plurality of electrodes in an address period, a capacitor having a first terminal coupled to a fourth power supply for supplying a second voltage that is higher than the first voltage, wherein the capacitor is charged with a third voltage, which is a difference between the second voltage and the scan voltage, by turning on the third switch.

The electrode driver may further include a fifth switch coupled between the second power supply and the third power supply, wherein when a voltage having a lower level than the first voltage is applied to the plurality of electrodes, the fifth switch is turned off to prevent a current path between the second power supply and the plurality of electrodes from being formed.

The plasma display device may further include at least one selection circuit having a first terminal coupled to at least one of the plurality of electrodes, and for applying a non-scan voltage to the at least one of the plurality of electrodes, and a second terminal for applying the scan voltage.

The voltage of the plurality of electrodes may gradually increase to a fourth voltage which is a sum of the sustain voltage and the third voltage, through a current path having the first power supply, the second switch, the fifth switch, the capacitor, and the second terminal of the selection circuit, when the second switch is turned on.

The electrode driver may further include: a diode having a cathode coupled to the plurality of electrodes; and a sixth switch having a first terminal coupled to an anode of the diode, and a second terminal coupled to the third power supply, and for gradually decreasing the voltage of the plurality of electrodes to a fifth voltage that is higher than the scan voltage.

When the sixth switch is turned on: the voltage of the plurality of electrodes may gradually decrease through a current path having the third power supply, the sixth switch, the diode, and the first terminal of the selection circuit to the fifth voltage; and the fifth voltage is higher than the scan voltage by a breakdown voltage of the diode.

Another embodiment of the present invention provides a driving apparatus for driving a plasma display device for displaying an image, the plasma display device having a plurality of discharge cells and a plurality of electrodes corresponding to the discharge cells, including: a first switch coupled between the plurality of electrodes and a first power supply for supplying a sustain voltage to the plurality of electrodes in a sustain period; and a second switch having a first terminal coupled to the first power supply, wherein the second switch has a second terminal coupled to the selection circuit, and the voltage of the second terminal gradually increases to the sustain voltage when the second switch is turned on in a portion of a reset period.

The driving apparatus may further include: a third switch coupled between the plurality of electrodes and a second power supply for supplying a first voltage that is lower than the sustain voltage; a fourth switch coupled between the plurality of electrodes and a third power supply for supplying a scan voltage to the plurality of electrodes in an address period; a fifth switch coupled between the second power supply and the third power supply, wherein the fifth switch is turned off to prevent a current path having the second power supply from being formed while a voltage lower than the first voltage is applied to the plurality of scan electrodes; and a capacitor having a first terminal coupled to the fourth power supply for supplying a second voltage that is higher than the first voltage, and for charging with a third voltage which is a difference between the second voltage and the scan voltage, when the fourth switch is turned on.

When the second switch is turned on: the voltage of the plurality of electrodes may gradually increase to a sum of the sustain voltage and the third voltage by a current path having the first power supply, the second switch, the fifth switch, and the capacitor.

The driving apparatus may further include: a plurality of selection circuits, each of which is coupled to the plurality of electrodes and having a first terminal applying a scan voltage in the address period, and a second terminal for applying a non-scan voltage; and a current path formed by turning on the second switch further comprises the second terminal of the selection circuit.

The driving apparatus may further include: a sixth switch having a first terminal coupled to the third power supply; and a Zener diode having a cathode coupled to the second terminal of the sixth switch and an anode connected to the plurality of electrodes, wherein the voltage of the plurality of electrodes gradually decreases to a fourth voltage that is higher than the scan voltage in the reset period if the sixth switch is turned off.

The fourth voltage may be a voltage that is higher than the scan voltage by a breakdown voltage of the Zener diode.

### BRIEF DESCRIPTION OF THE DRAWINGS

FIG. 1 is a diagram illustrating a plasma display device according to an exemplary embodiment of the present invention.

FIG. 2 is a diagram illustrating a driving waveform of a plasma display device according to an exemplary embodiment of the present invention.

FIG. 3 is a circuit diagram of a scan electrode driver according to an exemplary embodiment of the present invention.

FIG. 4 is a timing diagram for each switch for generating a driving waveform during a reset period in the scan electrode driver circuit of FIG. 3.

FIG. 5 is a circuit diagram illustrating the driving operation for forming a driving waveform in a rising period in a reset period according to the timing diagram of FIG. 4.

FIG. 6 is a circuit diagram illustrating the driving operation for forming a driving waveform in a falling period in a reset period according to the timing diagram of FIG. 4.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, and like reference numerals designate like elements throughout the specification.

When a first part is referred to as being “connected” or “coupled” to a second part, it could mean that the first part is directly connected to the second part, or it could also mean that the first part and the second part are “electrically connected” or “electrically coupled” having a third element in-between. Furthermore, when a part is referred to as “including” a constituent element, it does not mean that the part excludes other constituent elements, but it means that the part can further include other constituent elements, unless otherwise specified.

Hereinafter, a plasma display device according to an exemplary embodiment of the present invention and a driving apparatus thereof will be described in detail with reference to accompanying drawings.

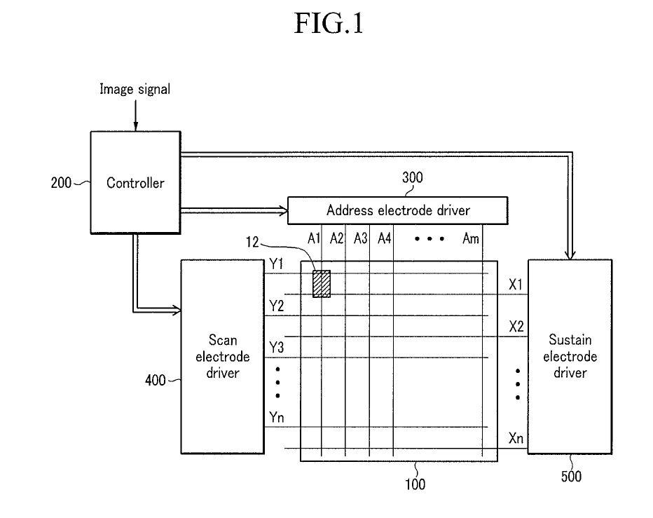

FIG. 1 is a schematic diagram illustrating a plasma display device according to an exemplary embodiment of the present invention.

As shown in FIG. 1, the plasma display device according to an exemplary embodiment of the present invention includes a plasma display panel (PDP) 100, a controller 200, an address electrode driver 300, a scan electrode driver 400, and a sustain electrode driver 500. The plasma display panel (PDP) 100 includes a plurality of address electrodes A1 to Am extending in a column direction, and a plurality of sustain electrodes X1 to Xn and a plurality of scan electrodes Y1 to Yn extending in a row direction. Hereinafter, an A electrode refers to the address electrode, an X electrode refers to the sustain electrode, and a Y electrode refers to the scan electrode. The plurality of Y electrodes Y1 to Yn are paired with the plurality of X electrodes X1 to Xn. Discharge cells are formed at the crossings of an adjacent Y electrodes Y1 to Yn and X electrodes X1 to Xn, and an A electrode A1 to Am.

The controller 200 receives a video signal from an outside source and outputs an address electrode driving control signal, a sustain electrode driving control signal, and a scan electrode driving control signal. The controller 200 drives one frame by dividing the one frame into a plurality of subfields each having a weight value.

The address electrode driver 300 receives the address electrode driving control signal from the controller 200 and applies a signal for selecting a target discharge cell for displaying an image to each of the A electrodes A1 to Am. The scan electrode driver 400 receives a scan electrode driving control signal from the controller 200 and applies a driving voltage to the Y electrodes Y1 to Yn. The sustain electrode driver 500 receives a sustain electrode driving control signal from the controller 200 and applies a driving voltage to the X electrodes X1 to Xn.

Hereinafter, the driving waveforms of a plasma display device according to an exemplary embodiment of the present invention will be described. For convenience, driving waveforms applied to a Y electrode, an X electrode and an A electrode which form one cell will be described.

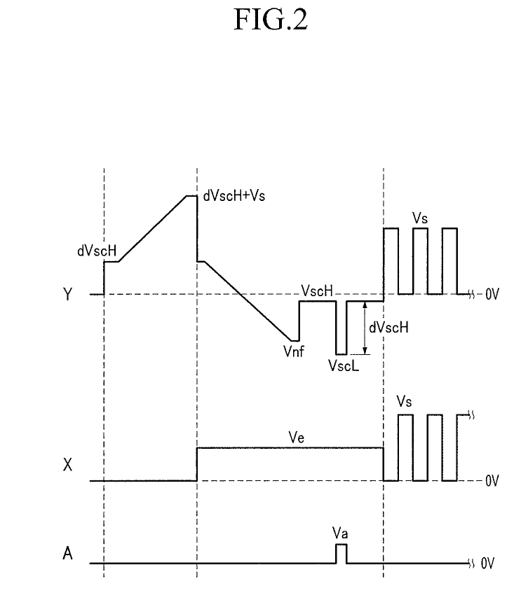

FIG. 2 is a timing diagram illustrating driving waveforms of a plasma display device according to an exemplary embodiment of the present invention.

As shown in FIG. 2, a reference voltage is applied to the A electrode and the X electrode in the rising period of the reset period. In FIG. 2, the reference voltage is shown as “0V”, and 0V refers to the reference voltage, hereinafter. Under this condition, an increasing voltage waveform is applied to the Y electrode, where the increasing voltage waveform gradually increases from a dVscH voltage to a (dVscH+Vs) voltage. Hereinafter, the reset rising waveform refers to the increasing voltage waveform. While applying the reset rising waveform to the Y electrode as described above, the voltage differences between the Y electrode and the X electrode, and between the Y electrode and the A electrode increase to greater than a discharge firing voltage, thereby inducing a weak discharge between the Y electrode and the X electrode, and between the Y electrode and the A electrode. Accordingly, a (−) wall charge is formed at the Y electrode, and a (+) wall charge is formed at the X and A electrodes due to the weak discharge induced by the reset rising waveform applied to the Y electrode.

After applying a 0V voltage and a bias voltage to the A electrode and the X electrode, respectively, a decreasing voltage waveform is applied to the Y electrode. The decreasing voltage waveform decreases from a dVscH voltage to a Vnf voltage. The bias voltage is shown as a Ve voltage in FIG. 2 and the Ve voltage refers to the bias voltage, hereinafter. While the reset falling waveform is applied to the Y electrode as described above, a weak discharge is induced between the Y electrode and the A electrode. Therefore, the (−) wall charge formed at the Y electrode is eliminated (or substantially eliminated), and the (+) wall charge formed at the X electrode and the A electrode is eliminated (or substantially eliminated). Generally, the size of the (Vnf-Ve) voltage is set to about a discharge firing voltage (Vfxy) between the Y electrode and the X electrode. As a result, the wall voltage between the Y electrode and the X electrode becomes about 0V, thereby substantially preventing a cell not induced by a discharge in the address period from misfiring during the sustain period.

Although it is not shown in the drawing, the reset falling waveform can be a voltage waveform that gradually decreases from 0V to the Vnf voltage after applying the dVscH voltage. As result, a time allocated to the falling period in the reset period can be reduced, thereby improving the contrast. Since the slope of the reset falling waveform does not become steeper, a strong discharge can be prevented from being induced.

In order to select a turn-on discharge cell in the address period, a scan voltage is sequentially applied to a plurality of Y electrodes after applying the Ve voltage to the X electrodes. In FIG. 2, the scan voltage is shown as a VscL voltage, and hereinafter, the VscL voltage refers to the scan voltage. Then, an address voltage is applied to an A electrode passing the target discharge cell among a plurality of discharge cells with the VscL voltage applied by the Y electrode. In FIG. 2, the address voltage is shown as a Va voltage, and, hereinafter, the Va voltage refers to the address voltage. As a result, an address discharge is induced between the A electrode receiving the Va voltage and the Y electrode receiving the VscL voltage, and between the Y electrode receiving the VscL voltage and the X electrode receiving the Ve voltage, thereby forming a (+) wall charge and a (−) wall charge at the A electrode and the X electrode, respectively. The VscL voltage can be set to be equal or lower than the Vnf voltage. A non-scan voltage higher than the VscL voltage is applied to at least one of the Y electrodes which do not receive the VscL voltage, and 0V is applied to non-selected discharge cells. The non-scan voltage is shown as VscH voltage in FIG. 2, and hereinafter, the VscH voltage refers to the non-scan voltage.

A sustain voltage is applied to the Y electrode and the X electrode in the sustain period. The sustain voltage is shown as a Vs voltage in FIG. 2, and, hereinafter, the Vs voltage refers to the sustain voltage. Then, 0V with the opposite phase is applied to the Y electrode and the X electrode, thereby inducing the sustain discharge. That is, the operation of simultaneously applying the Vs voltage to the Y electrode and 0V to the X electrode, and the operation of simultaneously applying 0V to the Y electrode and the Vs voltage to the X electrode are performed a number of times corresponding to a weight value of a corresponding subfield.

For convenience, the reset rising waveform and the reset falling waveform applied to the Y electrode for the reset period are shown and described as a ramp waveform in FIG. 2. However, in the present embodiment, any suitable waveform that gradually increases or decreases can be applied as the reset rising waveform and the reset falling waveform, such as an RC waveform or a waveform floated after gradually increasing or decreasing.

In addition, in FIG. 2, it is illustrated that the rising start voltage and the falling start voltage is the dVscH voltage that is a voltage difference (VscH-VscL) between the scan voltage and the non-scan voltage.

However, according to an exemplary embodiment of the present invention, in addition to the dVscH voltage, the rising start voltage or the falling start voltage may be set to any voltage that is lower than the discharge firing voltage of the X and Y electrodes (e.g., the Vs voltage).

Hereinafter, a scan electrode driver 400 having a simple circuit structure for generating a driving waveform of a Y electrode according to an exemplary embodiment of the present invention will be described.

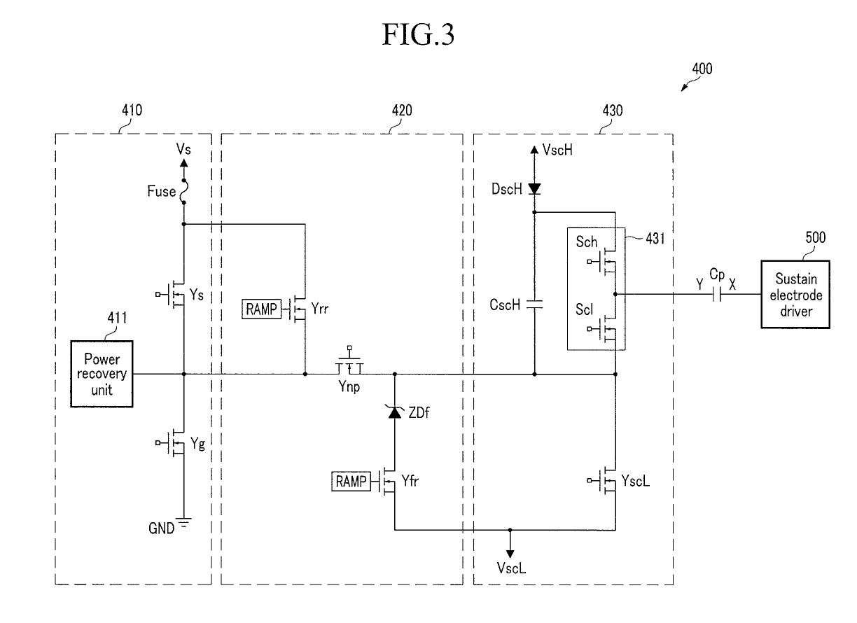

FIG. 3 is a circuit diagram illustrating a scan electrode driver according to an exemplary embodiment of the present invention. Although a switch is described as an n-channel field effect transistor (FET) having a diode hereinafter, the switch can be replaced with other elements which have identical or similar function to the n-channel FET in an exemplary embodiment of the present invention. In FIG. 3, the capacitive component formed of the X electrode and the Y electrode is described as a panel capacitor Cp.

As shown in FIG. 3, the scan electrode driver 400 includes a sustain driver 410, a reset driver 420, and a scan driver 430.

The sustain driver 410 includes a power recovery unit 411, a switch (Ys), and a switch (Yg). The sustain driver 410 alternately applies a Vs voltage and a GND voltage to a Y electrode in the sustain period.

In the sustain driver 410, the power recovery unit 411 includes a power recovery capacitor, a power recovery inductor, a switch forming a rising path, and a switching forming a falling path. The power recovery capacitor charges a voltage between the Vs voltage and 0V, for example, a Vs/2 voltage. If the switch forming the rising path or the falling path is turned on, an LC resonant current path is formed between the power recovery capacitor, the power recovery inductor and a panel capacitor Cp, thereby increasing or decreasing the voltage of the panel capacitor Cp. As power recovery unit 411 does not directly relate to the first exemplary embodiment, the description and a drawing thereof will be omitted.

A switch Ys is coupled between the Vs power supply supplying the Vs voltage and the Y electrode, and a switch Yg is coupled between a GND power supply supplying a GND voltage and the Y electrode. In the sustain period, if the switch Ys is turned on, a Vs voltage is applied to the Y electrode, and if the switch Yg is turned on, a GND voltage is applied to the Y electrode. A fuse is coupled between a Vs power supply and a switch Ys to prevent the elements of the node from being damaged or destroyed by receiving an excessively high voltage.

The reset driver 420 includes switches Yrr, Ynp, and Yfr, and a Zener diode ZDf. The reset driver 420 applies a reset rising waveform and a reset falling waveform to the Y electrode in the reset period.

The switch Yrr is coupled between the Vs power supply and the Y electrode in the reset driver 420. Then, the turn-on operation of the switch Yrr in the rising period of the reset period gradually increases the source voltage of the switch Yrr. Accordingly, the voltage of the Y electrode gradually increases to as high as (Vs+dVscH). As described above, since the switch Yrr is coupled to the Vs power supply, it dose not require an additional power supply for the reset rising voltage. Also, a fuse coupled to a Vs power supply is used when excessively high voltage is applied to the node at the moment the switch Yrr is turned on. Accordingly, an additional fuse coupled to the switch Yrr is not required.

The switch Yfr is coupled between a Y electrode and a VscL power supply that supplies the VscL voltage, and the Zener diode (ZDf) is coupled between the Y electrode and the switch Yfr. That is, the anode of the Zener diode ZDf is connected to the switch Yfr, and the cathode of the Zener diode ZDf is connected to the Y electrode. The location of the Zener diode (ZDf) and the switch Yfr may be switched. Through the turn-on operation of the switch Yfr in the falling period of the reset period, the cathode voltage of the Zener diode ZDf gradually decreases from a VscH voltage to a Vnf voltage which is the difference of VscL and the breakdown voltage of the Zener diode ZDf.

A switch Ynp has a drain coupled to the drain of the switch Yg, and a source coupled to the cathode of the Zener diode ZDf. A current path having a GND power supply is prevented from being formed by turning off the switch Ynp while applying a voltage lower than 0V to the Y electrode.

The scan driver 430 includes a selection circuit 431, a diode DscH, a capacitor CscH, and a switch YscL. The scan driver 430 sequentially applies a YscL voltage to a plurality of Y electrodes Y1 to Yn, and applies a YscH voltage to Y electrodes which do not receive the VscL voltage.

The selection circuit 431 includes a switch Sch and a switch Scl. The switch Sch is connected between the VscH power supply that supplies a VscH voltage and the Y electrode, and the switch Scl is connected between a power supply that supplies the VscL power voltage and the Y electrode. Although the selection circuit 431 connected to one Y electrode is shown in FIG. 3, a plurality of selection circuits are disposed to be connected to a plurality of the Y electrodes. Generally, a plurality of selection circuits are provided in an integrated circuit (IC) chip.

The anode of the diode DscH is coupled to the VscH power supply, and the cathode of the diode DscH is coupled to the switch Sch. The diode DscH forms a current path from the VscH power supply to the Y electrode when the switch Sch is turned on, and prevents a current from flowing to the VscH power supply.

The first terminal of the switch YscL is coupled to the VscL power supply, and the second terminal of the switch YscL is coupled to the switch Scl of the selection circuit 431. The capacitor CscH is coupled between the VscH power supply and the GND power supply. That is, the capacitor CscH has a first terminal coupled to the junction of the diode DscH and the switch Sch, and a second terminal coupled to the junction of the switch Ynp, the switch Scl and the switch YscL. The capacitor CscH and the switch YscL between the VscH power supply and the VscL power supply are coupled in series. During the initial driving of the plasma display device, the switch YscL is turned on to charge the dVscH voltage in the capacitor CscH.

Hereinafter, the driving operation of the scan electrode driver 400 of FIG. 3 for generating a driving waveform applied to the Y electrode for the reset period will be described.

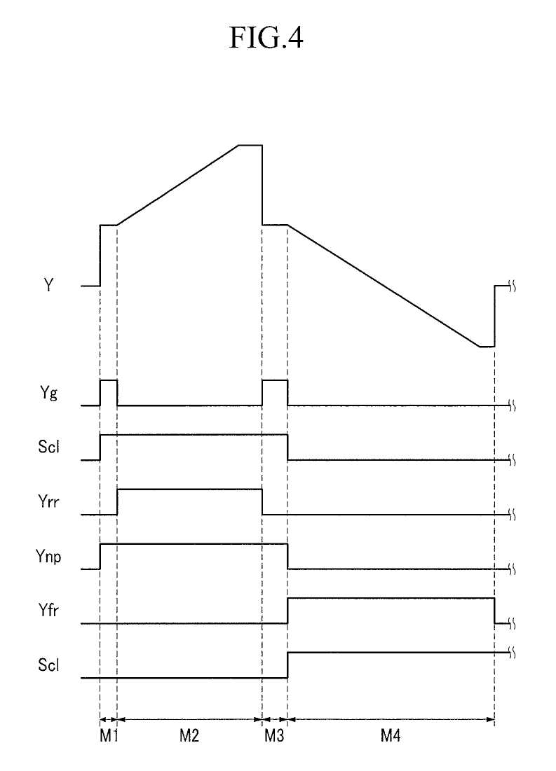

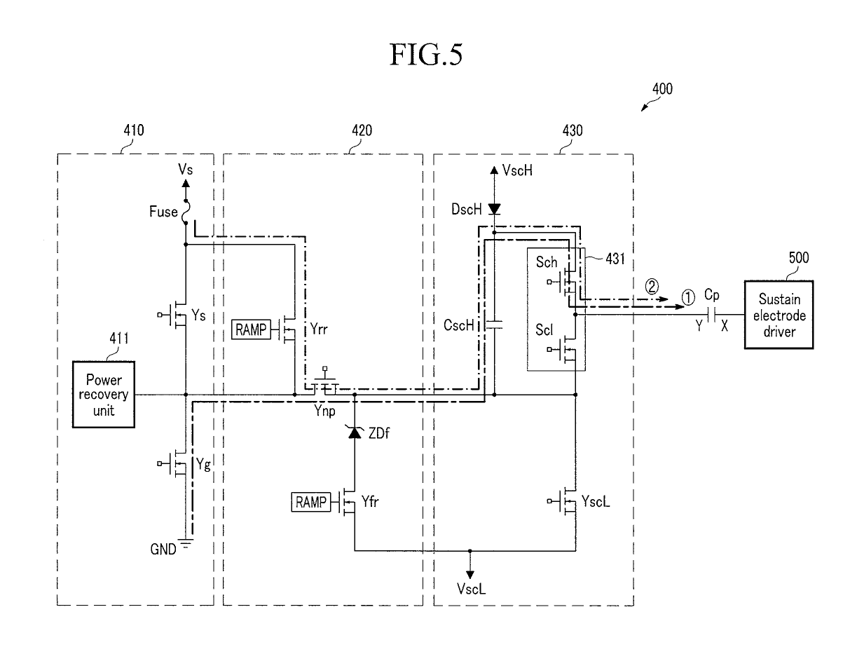

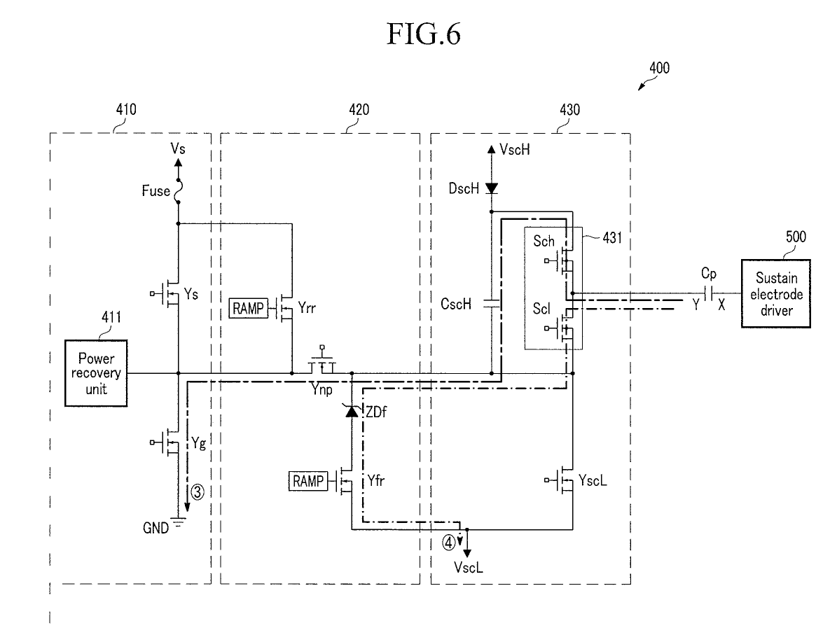

FIG. 4 is a timing diagram for each switch for generating a driving waveform of a reset period in the scan electrode driver of FIG. 3. FIG. 5 is a diagram showing a driving operation of the circuit for forming a driving waveform in a rising period of a reset period according to the timing diagram of FIG. 4, and FIG. 6 is a diagram showing a driving operation of the circuit for forming a driving waveform in a falling period of a reset period according to the timing diagram of FIG. 4.

First, during the initial driving of the plasma display device, the switch YscL is turned on to charge the dVscH voltage in the capacitor CscH.

As shown in FIG. 4, the switches Sch, Yg and Ynp are turned on in the first mode M1. Then, a dVscH voltage is applied to the Y electrode through a current path \textcircled{1} of a GND power supply, switches Yg and Ynp, a capacitor CscH, a switch Sch, and a panel capacitor Cp, Y electrode, as shown in FIG. 5.

In the second mode M2, a switch Yg is turned off and a switch Yrr is turned on. Then, a reset rising waveform is applied to the Y electrode through a current path \textcircled{2} of a Vs power supply, a switch Yrr, a switch Ynp, a capacitor CscH, a switch Sch, and a panel capacitor Cp. The voltage of the Y electrode gradually increases from the dVscH voltage by the Vs voltage through the current path \textcircled{2}, thereby applying a (dVscH+Vs) voltage to the Y electrode.

In the third mode M3, the switch Yrr is turned off, and the switch Yg is turned on. As shown in FIG. 6, a dVscH voltage is applied to the Y electrode through a current path \textcircled{3} of a panel capacitor Cp, a switch Sch, a capacitor CscH, switches Ynp and Yg, and a GND power supply.

In the fourth mode M4, the switches Sch, Yg, and Ynp are turned off, and the switches Yfr and Scl are turned on. As a result, a reset falling waveform is applied to the Y electrode through a current path \textcircled{4} of a panel capacitor Cp, a switch Scl, a Zener diode ZDf, a switch Yfr and a VscL power supply. Through the current path \textcircled{4}, the voltage of the Y electrode gradually decreases from the VscH voltage to the Vnf voltage. The Vnf voltage is higher than the VscL voltage, which is a negative voltage, by a breakdown voltage of the Zener diode ZDf.

In order to reduce the time allocated to the reset period and to prevent a strong discharge, a reset falling waveform gradually decreasing from 0V voltage to the Vnf voltage can be applied after applying a dVscH voltage and 0V voltage to the Y electrode in the falling period of the reset period.

A fifth mode M5 in an alternate embodiment is included between the third mode M3 and the fourth mode M4. In the fifth mode M5, the switches Yg, Ynp and Scl are turned on. As a result, a current path of a panel capacitor Cp, switches Scl, Ynp, and Yg, and a GND power supply is formed, and 0V voltage is applied to the Y electrode.

According to the present exemplary embodiment, a power supply for supplying a sustain voltage is coupled not only to a switch Ys that is turned on in the sustain period for applying a sustain voltage to the Y electrode, but also to a switch Yrr that is turned on in the rising period of the reset period for applying a reset rising waveform to the Y electrode. According to the described circuit structure, an additional power supply for supplying a voltage to the reset rising waveform is not required. Also, it is possible to exclude a fuse that prevents the excessively-high voltage from being applied to a node having a switch Yrr.

Since a power supply for applying a sustain voltage and a voltage for a reset rising waveform is commonly used in the present embodiment, no additional elements are required for preventing an unnecessary current path that would over-charge the power source.

The fuse connected to the sustain voltage power supply prevents excessively-high voltages from being applied to a node including a switch Ys that is turned on for applying a sustain voltage in the sustain period while a negative voltage is applied to the Y electrode, a switch Yrr that is turned on in the rising period of the reset period for applying the reset rising waveform, a switch Yfr that is turned on at the rising period of the reset period for applying the reset rising waveform, and a switch YscL that is turned on in the address period for applying a scan voltage.

Therefore, the circuit can be simplified and the manufacturing cost thereof can be reduced. Also, the reliability of the circuit can be improved because the internal potential applied to the elements while the plasma display device is driven is decreased.

According to exemplary embodiments of the present invention, the number of power supplies can be reduced, the circuit structure can be simplified, and the reliability of the circuit can be improved.

While the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a plasma display panel for displaying an image, the plasma display panel comprising a plurality of discharge cells and a plurality of electrodes corresponding to the discharge cells; and
an electrode driver for applying a driving voltage to the plurality of electrodes,
wherein the electrode driver comprises:
a first switch coupled between the plurality of electrodes and a first power supply for supplying a sustain voltage to the plurality of electrodes in a sustain period,
a second switch having a first terminal and a second terminal, the first terminal coupled to the first power supply, the second switch for gradually increasing a voltage of the second terminal to the sustain voltage.

2. The plasma display device of claim 1, wherein the electrode driver further comprises:
a third switch coupled between the plurality of electrodes and a second power supply for supplying a first voltage that is lower than the sustain voltage,
a fourth switch coupled between the plurality of electrodes and a third power supply for supplying a scan voltage to the plurality of electrodes in an address period,
a capacitor having a first terminal coupled to a fourth power supply for supplying a second voltage that is higher than the first voltage,
wherein the capacitor is charged with a third voltage, which is a difference between the second voltage and the scan voltage, by turning on the third switch.

3. The plasma display device of claim 2, wherein the electrode driver further comprises a fifth switch coupled between the second power supply and the third power supply, wherein when a voltage having a lower level than the first voltage is applied to the plurality of electrodes, the fifth switch is turned off to prevent a current path between the second power supply and the plurality of electrodes from being formed.

4. The plasma display device of claim 3, further comprising at least one selection circuit having a first terminal coupled to at least one of the plurality of electrodes, and for applying a non-scan voltage to the at least one of the plurality of electrodes, and a second terminal for applying the scan voltage.

5. The plasma display device of claim 4, wherein the voltage of the plurality of electrodes gradually increases to a fourth voltage which is a sum of the sustain voltage and the third voltage, through a current path having the first power supply, the second switch, the fifth switch, the capacitor, and the second terminal of the selection circuit, when the second switch is turned on.

6. The plasma display device of claim 4, wherein the electrode driver further comprises:
a diode having a cathode coupled to the plurality of electrodes; and
a sixth switch having a first terminal coupled to an anode of the diode, and a second terminal coupled to the third power supply, and for gradually decreasing the voltage of the plurality of electrodes to a fifth voltage that is higher than the scan voltage.

7. The plasma display device of claim 6, wherein, when the sixth switch is turned on:
the voltage of the plurality of electrodes gradually decreases through a current path having the third power supply, the sixth switch, the diode, and the first terminal of the selection circuit to the fifth voltage; and
the fifth voltage is higher than the scan voltage by a breakdown voltage of the diode.

8. A driving apparatus for driving a plasma display device for displaying an image, the plasma display device having a plurality of discharge cells and a plurality of electrodes corresponding to the discharge cells, comprising:
a first switch coupled between the plurality of electrodes and a first power supply for supplying a sustain voltage to the plurality of electrodes in a sustain period; and
a second switch having a first terminal coupled to the first power supply,
wherein the second switch has a second terminal coupled to the selection circuit, and the voltage of the second terminal gradually increases to the sustain voltage when the second switch is turned on in a portion of a reset period.

9. The driving apparatus of claim 8, further comprising:
a third switch coupled between the plurality of electrodes and a second power supply for supplying a first voltage that is lower than the sustain voltage;
a fourth switch coupled between the plurality of electrodes and a third power supply for supplying a scan voltage to the plurality of electrodes in an address period;
a fifth switch coupled between the second power supply and the third power supply, wherein the fifth switch is turned off to prevent a current path having the second power supply from being formed while a voltage lower than the first voltage is applied to the plurality of scan electrodes; and
a capacitor having a first terminal coupled to the fourth power supply for supplying a second voltage that is higher than the first voltage, and for charging with a third voltage which is a difference between the second voltage and the scan voltage, when the fourth switch is turned on.

10. The driving apparatus of claim 9, wherein, when the second switch is turned on:
the voltage of the plurality of electrodes gradually increases to a sum of the sustain voltage and the third voltage by a current path having the first power supply, the second switch, the fifth switch, and the capacitor.

11. The driving apparatus of claim 10, further comprising:
a plurality of selection circuits, each of which is coupled to the plurality of electrodes and having a first terminal for applying a scan voltage in the address period, and a second terminal applying a non-scan voltage; and
a current path formed by turning on the second switch further comprises the second terminal of the selection circuit.

12. The driving apparatus of claim 9, further comprising:
a sixth switch having a first terminal coupled to the third power supply; and
a Zener diode having a cathode coupled to the second terminal of the sixth switch and an anode connected to the plurality of electrodes,
wherein the voltage of the plurality of electrodes gradually decreases to a fourth voltage that is higher than the scan voltage in the reset period if the sixth switch is turned off.

13. The driving apparatus of claim 12, wherein the fourth voltage is a voltage that is higher than the scan voltage by a breakdown voltage of the Zener diode.
